(19) United States
(12) Patent Application Publication
(10) Pub. No.: US 2012/0047524 A1
(43) Pub. Date: Feb. 23, 2012

(54) AUDIENCE COUNTING SYSTEM AND METHOD

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/910,815

(22) Filed: Oct. 24, 2010

(30) Foreign Application Priority Data
Aug. 20, 2010 (TW) 99127904

(51) Int. Cl. H04H 60/29

(52) U.S. Cl. 725/9

(57) ABSTRACT

An audience counting method includes, capturing an image of a scene in front of a screen with a camera. Detecting the image from the camera to determine whether there is a person in front of the screen. Acquiring information of the person in front of the screen according to the image upon the condition that there is a person in front of the screen and storing the information acquired during a preset period. Comparing current information acquired with the stored information; and outputting a control signal upon the condition that the current information is different from all of the information stored earlier; then counting according to the control signal.

### BACKGROUND

1. Technical Field

The present disclosure relates to an audience counting system and method.

2. Description of Related Art

Outdoor media has grown vigorously in recent years, things like electronic advertisement billboards, which can be put in different places where many people visit, such as building entrances, subway stations, and supermarkets. Sometimes, the contents of the outdoor media can be made more effective if changed according to audience reaction and/or changing demographics. Therefore, a need exists for operators to be able to obtain data from the outdoor media remotely, such as the number of people who are attracted by visual and acoustic effect of the outdoor media. However, when different members of the audience are attracted more than once, the true count of the audience is not accurate.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic diagram of an exemplary embodiment of an audience counting system.

FIG. 2 is a block diagram of the audience counting system of FIG. 1, the audience counting system includes a storage unit.

FIG. 3 is a block diagram of the storage unit of FIG. 2.

FIG. 4 is a flowchart of an exemplary embodiment of an audience counting method.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

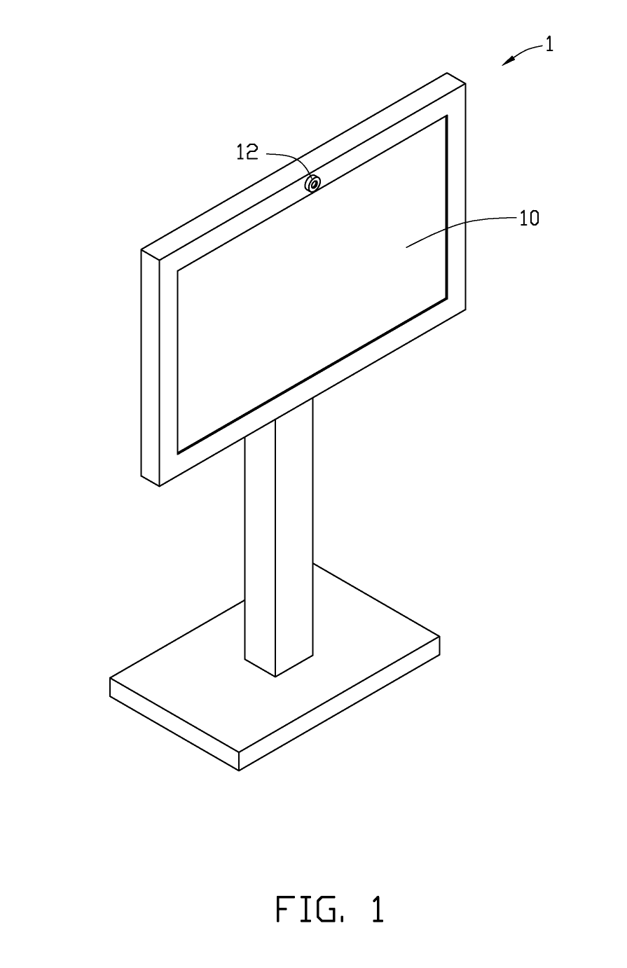

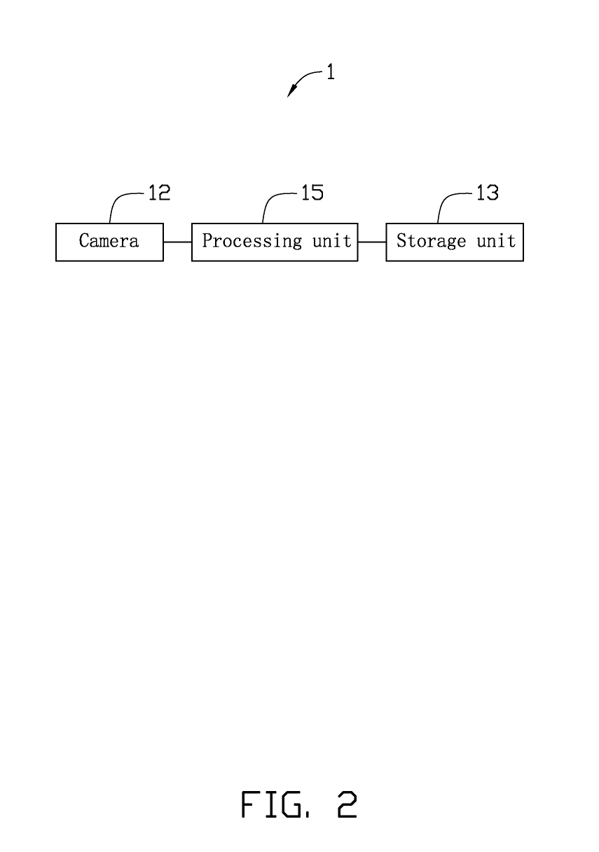

Referring to FIGS. 1 and 2, an exemplary embodiment of an audience counting system 1 includes a screen 10, a camera 12, a storage unit 13, and a processing unit 15. The audience counting system 1 can count the number of people in the audience who are attracted by visual and acoustic effect of what the screen 10 displays.

The camera 12 captures images of a scene in front of the screen 10.

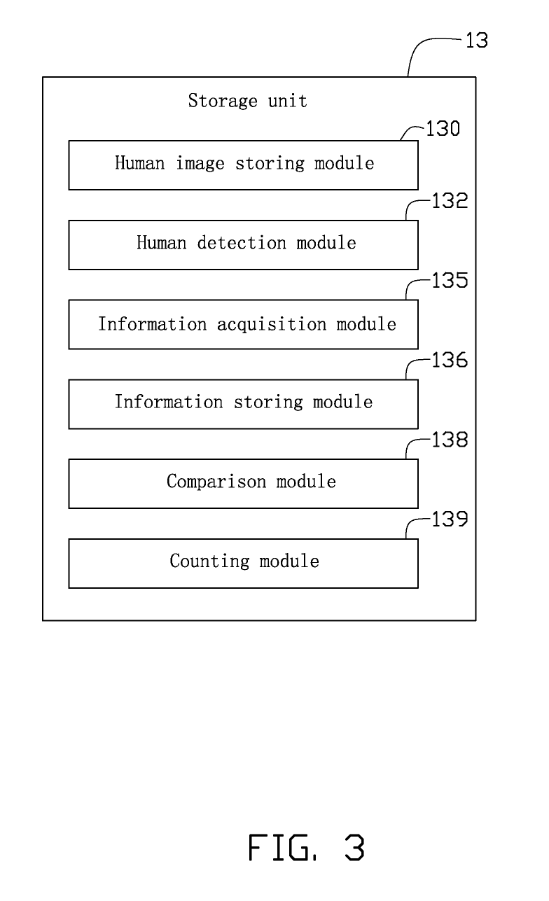

Referring to FIG. 3, the storage unit 13 includes a human image storing module 130, a human detection module 132, an information acquisition module 135, an information storing module 136, a comparison module 138, and a counting module 139 which may include one or more computerized instructions and are executed by the processing unit 15.

The human image storing module 130 stores a plurality of human images. The human images include a plurality of images of different people, such as old people, young people, males, and females. The camera can obtain the plurality of human images in advance.

The human detection module 132 checks the image captured by the camera 12 to determine whether there is a person in front of the screen 10. In one embodiment, the human detection module 132 compares the image captured by the camera 12 with the human images stored in the human image storing module 130 to determine whether there is a person in front of the screen 10. If a portion of the image captured by the camera 12 is similar to a human image of the plurality of human images stored in the human image storing module 130, it is determined that there is a person in the image, namely, there is a person in front of the screen 10. If the image captured by the camera 12 is different from all human images stored in the human image storing module 130, it is determined that there are no people in the image, namely, there are no people in front of the screen 10. If two or more portions of the image captured by the camera 12 are similar to two or more human images of the plurality of human images stored in the human image storing module 130, it is determined that there are two or more people in front of the screen 10. In other embodiments, the human detection module 132 can use other well-known human recognition technologies when analyzing the images.

The information acquisition module 135 acquires information of the person in front of the screen 10 according to the image. The information of the person includes age, gender, dress, and hairstyle of the person. The information acquisition module 135 may use a well-known human recognition technology when analyzing the images.

The information storing module 136 stores the information acquired by the information acquisition module 135 during a preset period of time, such as two hours. In other words, at the time the audience counting system 1 is activated, there is no data stored in the information storing module 136. After the information acquisition module 135 acquires information of a person in front of the screen 10, the information of the person is stored in the information storing module 136. When the preset period of time elapses, the information storing module 136 clears the data stored in the information storing module 136.

The comparison module 138 compares current information acquired by the information acquisition module 135 with the information stored in the information storing module 136. If the current information is same as one of the information stored in the information storing module 136, it is determined that the current person is same as one of the people who has been in front of the screen 10 at an earlier time in the preset period time. If the current information is different from all of the information stored in the information storing module 136, it is determined that the current person is different from all of the people who have been in front of the screen 10 at an earlier time in the preset period time. At this time, the comparison module 138 outputs a control signal to the counting module 139.

The counting module 139 counts when the comparison module 138 outputs the control signal. During the preset period of time, the number the counting module 139 counts is equal to the number of the people who have been in front of the screen 10.

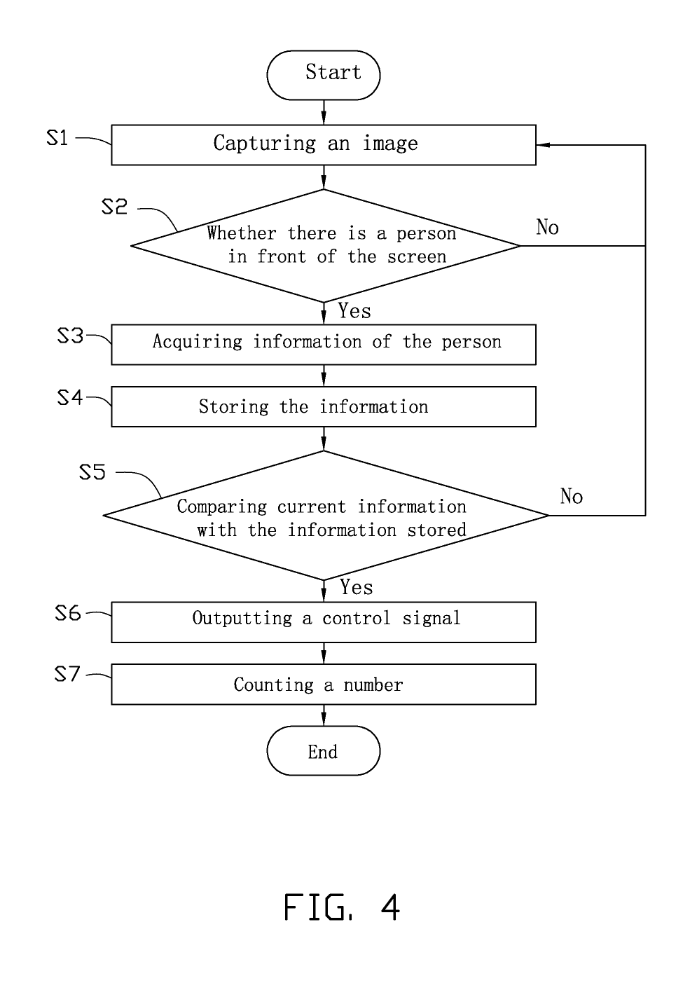

Referring to FIG. 4, an exemplary embodiment of an audience counting method includes the following steps.

In step S1, the camera 12 captures an image of a scene in front of the screen 10.

In step S2, the human detection module 132 detects the image from the camera 12 to determine whether there is a person in front of the screen 10. If there is a person in front of the screen 10, the process flows to step S3. If no people are in front of the screen 10, the process returns to step S1. In the embodiment, the human detection module 132 compares the image captured by the camera 12 with the human images stored in the human image storing module 130 to determine whether there is a person in front of the screen 10. If a portion of the image captured by the camera 12 is similar to a human image of the plurality of human images stored in the human image storing module 130, it is determined that there is a person in the image captured by the camera 12, namely, there is a person in front of the screen 10. If the image captured by the camera 12 is different from all human images stored in the human image storing module 130, it is determined that there is no people in the image captured by the camera 12, namely, there is no people in front of the screen 10. If two or more portions of the image captured by the camera 12 are similar to two or more human images of the plurality of human images stored in the human image storing module 130, it is determined that there are two or more people in front of the screen 10. In other embodiments, the human detection module 132 can use other well-known human recognition technologies when analyzing the images.

In step S3, the information acquisition module 135 acquires information, such as age, and gender of the person in front of the screen 10 according to the image.

In step S4, the information storing module 136 stores the information acquired by the information acquisition module 135 during a preset period of time.

In step S5, the comparison module 138 compares current information acquired by the information acquisition module 135 with the information stored in the information storing module 136. If the current information is the same as some of the information stored in the information storing module 136, it is determined that the current person is same as one of the people who has been in front of the screen 10 at an earlier time in the preset period time, and the process returns to step S 1. If the current information is different from all of the information stored in the information storing module 136, it is determined that the current person is different from all people who have been in front of the screen 10 at an earlier time in the preset period time, and the process flows to step S6.

In step S6, the comparison module 138 outputs a control signal to the counting module 139.

In step S7, the counting module 139 counts according to the control signal.

The foregoing description of the exemplary embodiments of the disclosure has been presented only for the purposes of illustration and description and is not intended to be exhaustive or to limit the disclosure to the precise forms disclosed. Many modifications and variations are possible in light of everything above. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. An audience counting system comprising:
a screen;
a camera to capture an image in front of the screen;
a processing unit connected to the cameras; and
a storage system connected to the processing unit and storing a plurality of programs to be executed by the processing unit, wherein the storage system comprises:
a human detection module to check the image captured by the camera to determine whether there is at least one person in front of the screen;
an information acquisition module to acquire information of the at least one person in front of the screen according to the image, upon the condition that there is at least one person in front of the screen;
an information storing module to store the information acquired by the information acquisition module during a preset period of time;
a comparison module to compare current information acquired by the information acquisition module with the information stored in the information storing module, wherein the comparison module outputs a control signal upon the condition that the current information is different from the information stored in the information storing module; and
a counting module to count according to the control signal.

2. The audience counting system of claim 1, wherein the storage system further comprises a human image storing module storing a plurality of different human images, the human detection module compares the image captured by the camera with the human images stored in the human image storing module to determine whether there is at least one person in front of the screen.

3. The audience counting system of claim 1, wherein the information of the at least one person comprises age, gender, dress, and hairstyle of the at least one person.

4. An audience counting method comprising:
capturing an image of a scene in front of a screen by a camera;
detecting the image from the camera to determine whether there is at least one person in front of the screen;
acquiring information of the at least one person in front of the screen according to the image upon the condition that there is at least one person in front of the screen;
storing the information acquired during a preset period of time;
comparing current information acquired with the information stored;
outputting a control signal upon the condition that the current information is different from all of the information stored earlier; and
counting according to the control signal.

5. The audience counting method of claim 4, wherein “detecting the image from the camera to determine whether there is at least one person in front of the screen” comprises:
comparing the image captured by the camera with the human images stored in advance to determine whether there is at least one person in front of the screen.

6. The audience counting method of claim 4, wherein the information of the at least one person comprises age, gender, dress, and hairstyle of the at least one person.
